(19) United States
(12) Patent Application Publication
(10) Pub. No.: US 2024/0066332 A1
(43) Pub. Date: Feb. 29, 2024

(54) Adhering face mask

(71) Applicant: Jorge Alberto Contreras, Rocky Hill, CT (US)

(72) Inventor: Jorge Alberto Contreras, Rocky Hill, CT (US)

(21) Appl. No.: 18/453,557

(22) Filed: Aug. 22, 2023

Related U.S. Application Data
(60) Provisional application No. 63/400,358, filed on Aug. 23, 2022.

(51) Int. Cl. A62B 18/02; A62B 18/08

(52) U.S. Cl. CPC A62B 18/025; A62B 18/084

(57) ABSTRACT

The adhering face mask is a device that allows the user to breathe filtered air without discomfort. It adheres to user's face with an adhesive gasket and creates a seal. The adhesive face mask creates an air pocket for the user preventing the mask from rubbing against the user's face. The filter housing gasket maintains a sealed air pocket when the filter housing assembly is attached. It comprises a filter housing assembly that uses a set of magnets embedded in it's body to attach to a matching set of magnets embedded in the adhering face mask body. It comprises a filter cartridge that adheres to the filter housing assembly and filters different kinds of air quality.

### BACKGROUND OF THE INVENTION

This invention relates to face masks which have been used for the purpose of filtering air for the user. The problem with these face masks is that they're inefficient and don't provide adequate protection for the user. In addition to this there is added discomfort to the ears, head, and face from wearing these face masks for extended periods. They are usually skin reactions from the different types of materials that they are made of.

### SUMMARY BRIEF SUMMARY OF THE INVENTION

The adhering face mask creates an air pocket in between the mask and the user's face, allowing the user to breathe in comfort. The back side of the adhering face mask is in the shape of a facial profile. The adhesive gasket assembly body matches the facial profile and bonds with the adhering face mask creating a seal. The adhesive gasket assembly is comprised of but not limited to an adhesive gasket assembly body, and double sided adhesive strips that adhere the mask to the user's face. The front side of the adhering face mask is embedded with a set of magnets. The filter housing gasket is bonded to front side of the adhering face mask creating a seal. The filter housing assembly is comprised of a set of matching magnets embedded in the back side of the of the filter housing assembly, and houses a filter cartridge. The filter housing assembly attaches and detaches from the adhering face mask body using the set of magnets magnetic forcefields. This embodyment of the invention provides adequate protection to the user by having seals that prevent unfiltered air from getting inside the air pocket. It solves the problem of user discomfort by adhering directly to the users face.

### BRDESCRIPTION OF THE DRAWINGS

FIG. 1 is an isometric view of the adhering face mask.

FIG. 2 is an exploded view of the adhering face mask and all of its components.

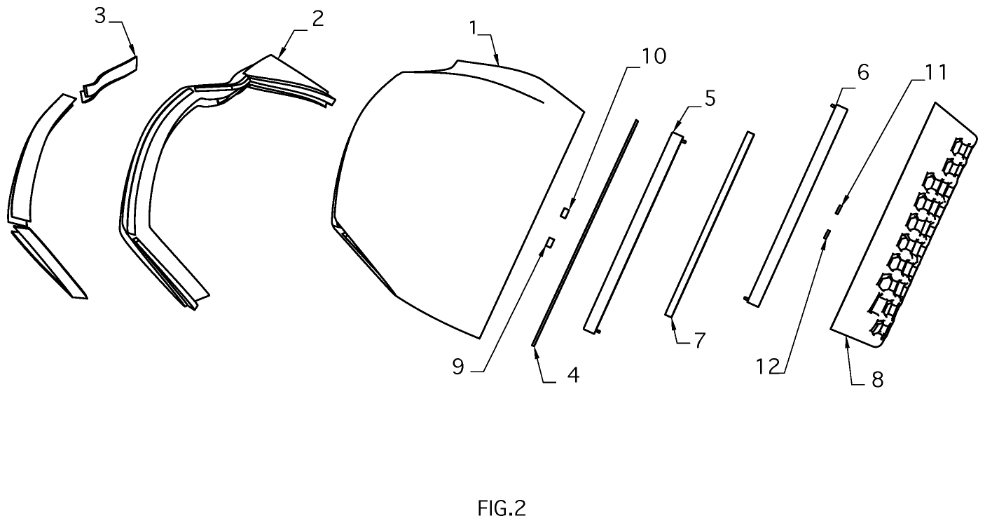

FIG. 3 is an isometric exploded view showing the adhesive gasket assembly matching up to the back side of the adhering face mask body.

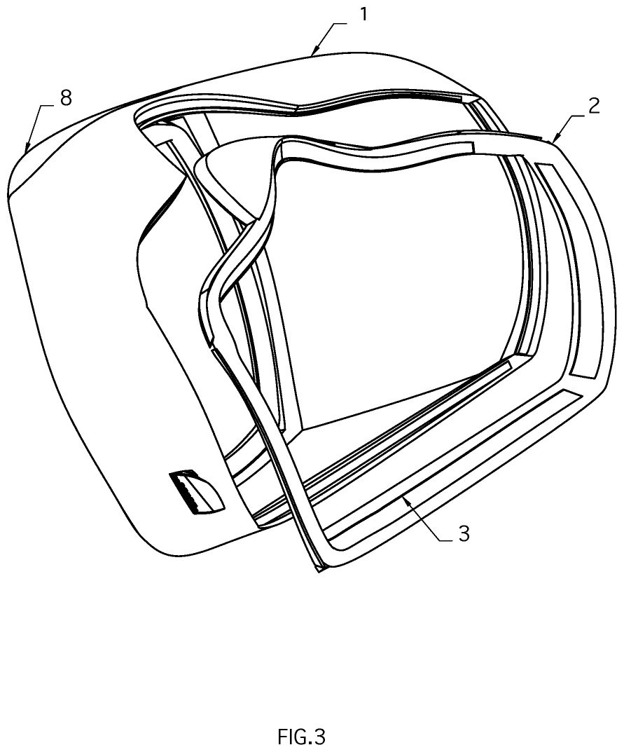

FIG. 4 is an isometric exploded view of the adhesive gasket assembly with the double sided adhesive strips in the shape of sections of the facial profile.

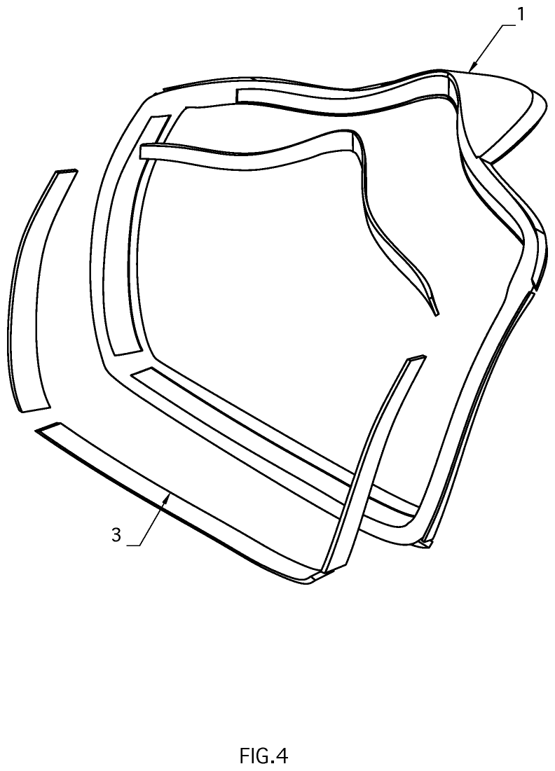

FIG. 5 is an isometric exploded view of the adhesive gasket assembly with the double sided adhesive strip in the shape of a facial profile.

FIG. 6 is an isometric exploded view of the filter housing gasket matching up to the front side of the adhering face mask body.

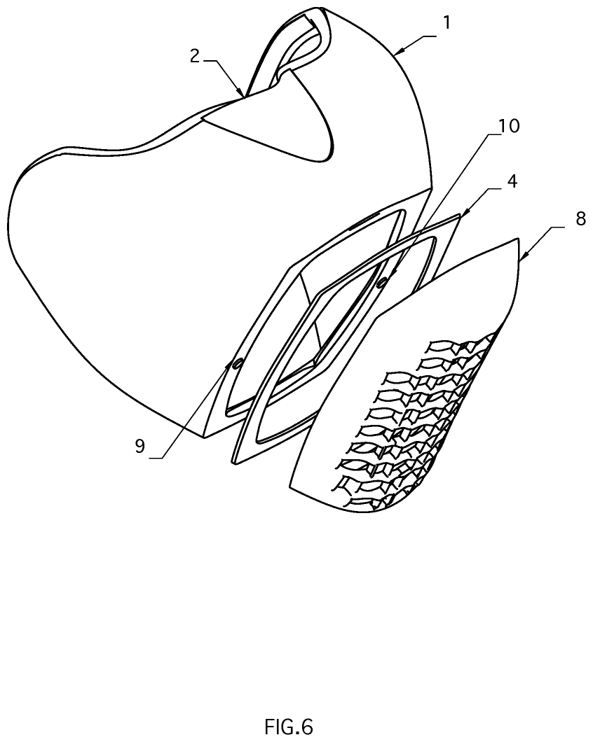

FIG. 7 is an isometric exploded view of the filter housing assembly housing the filter cartridge.

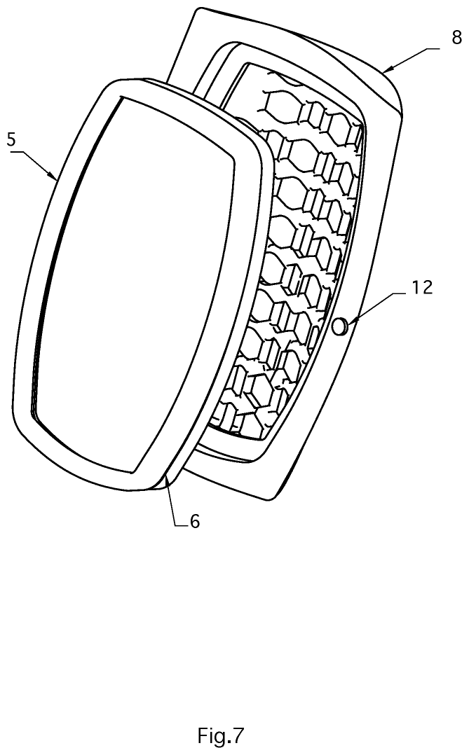

FIG. 8 is an isometric exploded view of the filter cartridge.

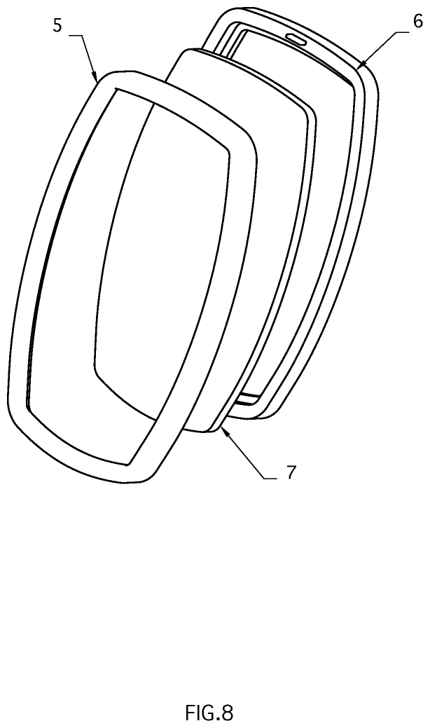

F

### ITEMS

1. adhering face mask body
1. adhesive gasket assembly body
2. double sided adhesive strips
3. filter housing gasket
4. filter cartridge side A
5. filter cartridge side B
6. filter material
7. filter housing assembly
9. magnet 9
10. magnet
11. magnet
12. magnet 12

### DETAILED DESCRIPTION

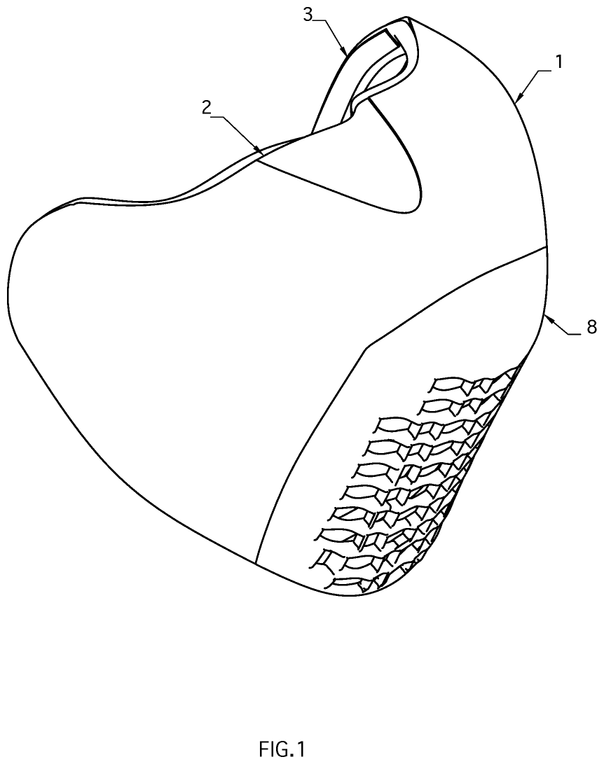

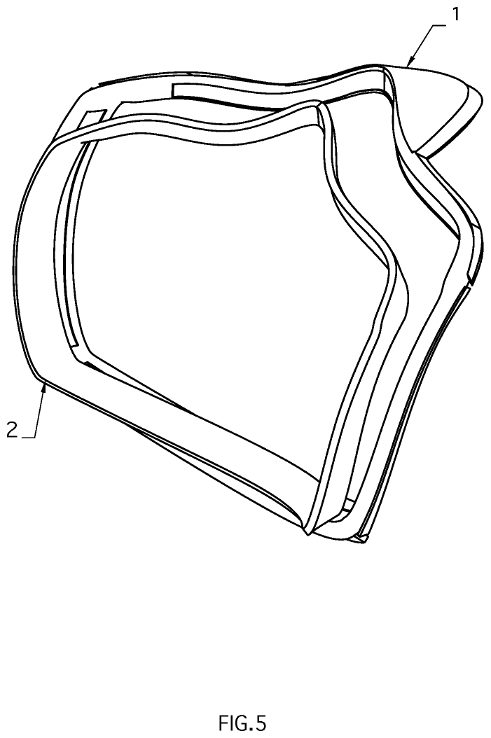

I will now describe the invention in more detail with reference to the drawings. The adhering face mask FIG. 1, comprising of but not limited to an adhering face mask body 1. With a back side profile in the shape of a facial profile. Having an adhesive gasket assembly body 2 that matches the back side profile and is bonded to it. Having a set of double sided adhesive strips 3 that can be made in sections of the facial profile or in the completed shape of the facial profile FIG. 5. The front of the adhering face mask body 1 is embedded with a set of magnets 9-10, that align to a set of magnets 11-12 that are embedded in the back of the filter housing assembly 8. The filter housing gasket 4 is bonded to the front side of the adhering face mask body 1. There's a filter housing assembly comprising of a hole pattern in the front side of the body to let air in, and a slotted profile in the back side of the body to house the filter cartridge 5-7. The filter housing assembly detaches and attaches to the adhering face mask body using the magnetic force from the set of magnets. Having a Filter cartridge comprising of but not limited to having a filter cartridge side A 5, and a filter cartridge side B 6, with a filter material 7 bonded in the middle of both of the cartridge sides. an adhesive is applied to the exposed side of filter cartridge side B in order to attach the filter cartridge to the slotted profile on the filter housing assembly.

1. An adhering face mask that adheres to the users facial profile comprising of but not limited to:
a. an adhering face mask body with a facial profile on the back side, and a set of magnets embedded on the front side,
b. an adhesive gasket assembly that's bonded to the back side profile of the adhering face mask body,
c. a filter housing gasket that's bonded to the front side profile of the adhering face mask body,
d. a filter housing assembly that attaches to the adhering face mask using a set of magnets embedded in the filter housing assembly and a set of magnets embedded in the adhering face mask,
e. a filter cartridge that attaches to a slot in the filter housing assembly.

2. The adhering face mask of claim 1 further characterized and not limited to having an adhesive gasket assembly that's made out of silicone.

3. The adhering face mask of claim 2 further characterized and not limited to having an adhesive gasket assembly with one side in a shape of a facial profile, and the other side matching the profile on the back side of the adhering face mask.

4. The adhering face mask of claim 2 further characterized and not limited to having double sided adhesive strips that can be attached to and removed from the adhesive gasket assembly.

5. The adhering face mask of claim 2 further characterized in that the double sided adhesive strips can be shaped in but not limited to sections of the human facial profile or in the entire shape of the human facial profile.

6. The adhering face mask of claim 2 further characterized in that the double sided adhesive strips can be made of but not limited to a silicone based adhesive material.

7. The adhering face mask of claim 1 further characterized but not limited to having a filter housing gasket that is made of a silicone based material and bonded to the front side profile of the adhering face mask.

8. The adhering face mask of claim 7 further characterized in that the filter housing gasket is made of but not limited to a silicone based material bonded to the back side of the filter housing assembly.

9. The adhering face mask of claim 1 further characterized in that the filter housing assembly is comprising of but not limited to,
a. a set of magnets embedded in the filter housing assembly that are aligned and attach to a set of magnets embedded in the adhering face mask,
b. a hole pattern of any shape on the front side that allows air to flow in, and a filter cartridge slot on the back side.

10. The adhering face mask of claim 1 further characterized in that the filter cartridge is comprising of but not limited to,
a. filter cartridge side A,
b. filter cartridge side B,
c. filter material thats located between the two sides of the filter cartridge
